(19) United States
(12) Patent Application Publication
(10) Pub. No.: US 2023/0326306 A1
(43) Pub. Date: Oct. 12, 2023

(54) Equivalency Machine For Facilitating In-Store Checkout Process For Items Ordered Online

(71) Applicant: ETHOR IP CORP., Dover, DE (US)

(72) Inventors: Gary Kenneth Ziegler, Calgary (CA); James John Hume, Parksville (CA)

(21) Appl. No.: 17/988,597

(22) Filed: Nov. 16, 2022

Related U.S. Application Data
(60) Provisional application No. 63/329,727, filed on Apr. 11, 2022.

(51) Int. Cl. G07G 1/00; G06Q 20/20; G06Q 30/06

(52) U.S. Cl. CPC G07G 1/0036; G06Q 20/20; G06Q 30/0601

(57) ABSTRACT

The present invention provides a system for comparing orders placed online with items scanned or entered into the merchants point of sale system in-store, the system comprising of (a) one or more point of sale agents linkable to one or more point of sale systems; (b) an order manager linked directly or through an API to the one or more point of sale agents; (c) a database to store order information for orders that were placed online; (d) a unique identifier that links the order that was placed online with the Picker and with items that have been entered into the POS system; (e) a rules engine that compares orders placed online with the items that have been scanned and/or entered into the point of sale system; and (f) a reporting system that distributes order details to the necessary parties after the in-store transaction is completed.

### CROSS-REFERENCE TO PRIOR APPLICATIONS

This application claims priority to U.S. Provisional Application Ser. No. 63/329,727 filed Apr. 11, 2022 and entitled System And Method For Online Ordering Services, which is hereby incorporated herein by reference in its entirety.

### U.S. Government Support

Not applicable.

### BACKGROUND

### Area of the Art

This disclosure relates to a system and method for facilitating the in-store checkout process for products that were purchased online. More specifically, it is a system and method for determining whether each item gathered in-store is either identical to an item that was selected online, or is an acceptable alternative for an item selected online based on a set of rules or combination of the two.

### Description of the Background

This invention relates to a system and method that improves the accuracy and efficiency of in-store transactions that are initiated by customers using online digital ordering services. Such services have become increasingly popular because they enable customers to avoid the time and inconvenience of having to go to stores themselves and gather items throughout the store to make purchases of groceries and other products. More recently, they have gained popularity because they enable customers to avoid exposure to Covid they perceive may exist at retail locations. As the risk of Covid subsided, these services continue to be popular with such customers because they came to appreciate the convenience of such services. Many merchants, such as restaurants, grocery stores and liquor stores, now rely on these services to grow and maintain their level of business using either their own website or one of a number of e-commerce Providers, such as Instacart, DoorDash, Uber Eats and Drizly, to provide the interface between customers and those merchants.

An example of the use of this service is a customer ordering groceries through a Provider, like one of the entities described above. The customer accesses the Provider's website, which shows a number of items available at a particular store. The customer browses through through those items, selects desired items, and adds them to theft online shopping cart on the Provider's website.

When a customers selection is complete, the customer clicks on the Provider's website checkout button. As part of the online checkout process, the customer enters credit card information, or identifies credit card information previously provided to the Provider, to pay for the items selected in the shopping cart. The Provider then charges the total price of those items to the customer's credit card. As a result of this transaction, the Provider pays the appropriate fee to the entity issuing the credit for the transaction—typically a Visa/MasterCard/Amex affiliated entity.

After the customer's order is charged by the Provider to a credit card, the Provider sends the order to a “Picker,” who is generally an independent contractor that accepts orders from the Provider for fulfillment, but who could also be a store employee. The Picker then goes to the selected grocery store (or just to the store shelves if the Picker is a store employee) and “picks” the items selected by the customer on the Provider's website from the store shelves as if the Picker were shopping for itself and pays for items the Picker has selected from the shelves at the store checkout. The grocery store cashier (or the Picker in the case of self checkout) inputs the selected items at the point of sale, typically using a scanner (and other tools, such as a scale), to calculate the total cost of the selected items, as with other shoppers. The Picker pays for the order, using a credit card, and the transaction is complete. As with the initial transaction between the customer and the Provider, the grocery store pays the appropriate fee to the entity issuing the credit for that transaction.

The current process suffers from two fundamental problems.

First, because the order is entered twice—once online with the Provider and once at the merchant—the credit card fees paid to the bank are unnecessarily increased, and could be as much as doubled, depending the amount of the fee agreement with the Provider and with the merchant. This unnecessary cost typically is borne by the merchant, but may be passed off to the customer or to the Provider, or some combination of the two.

Second, the process is subject to human error of the Picker, resulting in the customer receiving items that are different from what the customer ordered or in the customer receiving unacceptable substitute products for items that are unavailable on the merchant's shelves. For example, the Picker may select an incorrect item, fail to select a requested item, or select an incorrect size for an item. The Picker may also fill an order with an unacceptable substitute for an item selected by the customer that is not available on the shelves of the store. For example, the brand of a commodity like sugar or salt is unlikely to make a difference, and there may be reasonable substitutes for a brand that is out of stock. In contrast, a gluten-free item or a fat-free item would likely not have acceptable substitutes in products that do not have those characteristics.

Several solutions have been proposed, however, inventions to date revolve around items ordered online are entered into the system and there is no anticipation that alternative items could be substituted.

United States Patent Publication No. US20130275238 to Ramaratnam et al. discloses a system and method by which a person can order online and pay for the order at the POS if the person either does not have a credit card or is unwilling to provide credit card information over the Internet. Because the person is paying at the store, the person can add items selected while at the store to the online order, and pay for the combined online/in store order. Moreover, there may be some delay between the time of the online order and the time of the POS payment, the system must account for price changes that may occur in the interim. identifiers are used only to identify the customer and barcodes are used in the conventional way. Neither is used in the manner of the present invention. Ramaratnam does not discloses selection of alternative products or the way Pickers fulfill orders.

United States Patent Publication No. US20160101936 to Chamberlin application relates to a system and method that determines whether a selected item corresponds to the ordered item based on its physical attributes—for example, shape/size, weight or visual appearance. Chamberlin does not disclose selection of alternative products and does not relate to the way Pickers fulfill orders as claimed in instant application.

### SUMMARY OF THE INVENTION

The present invention is directed to a system and computer-implemented method of linking online orders with in-store point of sale and payment systems to facilitate a cheaper, faster, more accurate and more efficient checkout process when collecting the items that were purchased online. Through a unique identifier that is tied to the online purchase, the system compares the items that have been scanned at the in-store checkout with the order that was placed online and then uses an Equivalency Machine to determine whether or not the items that have been entered into the point of sale system meet the acceptable criteria of the order that was placed online.

Acceptable criteria may include but are not limited to characteristics such as SKU, category, price, size, weight and/or product manufacturer. After it is determined that the items entered into the point of sale system meet the acceptable criteria of the order placed online, the credit/debit card payment process may be bypassed entirely. Alternatively, the in-store payment process may be altered to work in conjunction with the online payment process by linking the online payment with the in-store payment through a network. Once the payment process is either bypassed or completed, the details of the transaction are saved and may be transferred to the necessary parties.

This ensures that the items that have been collected from the store meet the acceptable requirements associated with the order that was placed online and that all interested parties have an accurate record of what items were gathered in-store and whether or not there are any discrepancies between those items and the items purchased online. It also reduces the cost to the merchant for processing the payment and increases the speed of the checkout process when bypassing the payment process.

Although the order that was placed online has already been paid for online, typically the Picker is still required to go through a checkout process at the merchant and pay for that item using a payment card, which results in paying payment processing fees twice for the same order.

Additionally, it is common that the items ordered online are out of stock at the store-level or that there are other differences between the item(s) ordered and the item(s) that are available in the store, but similar alternatives are available and acceptable as substitutes. This leads to discrepancies between the items being gathered in-store and the items that were already purchased and paid for online. This process results in costly payment card fees being charged twice for the same order and a lack of transparency regarding the items that were gathered in the store versus what was purchased online. It also creates inefficiencies of slowing down the checkout process by requiring the person gathering the items to go through the payment process even though the items have already been paid for online and requiring the person gathering the items to carry a payment card to pay for these items, which then has to be managed and tracked by the company providing the payment card(s).

The present invention is designed to overcome one or more of these limitations, reduce some of the costly payment card fees for the merchant, create greater transparency between what items were gathered versus what was purchased online and create a faster and more efficient checkout process.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### DESCRIPTION OF THE DRAWINGS

FIG. 1 illustrates a system in accordance with the present invention

FIG. 2 illustrates Equivalency Machine connected to online order, in-store order and substitutions

FIG. 3 illustrates detailed comparison of the items that were purchased online with the items that have been entered into the in-store point of sale system

FIG. 4 illustrates one embodiment of the reporting engine

### DETAILED DESCRIPTION OF THE INVENTION

Unless defined otherwise, all technical and scientific terms used herein have the same meaning as commonly understood by one of ordinary skill in the art to which this invention belongs. Also, unless indicated otherwise, except within the claims, the use of “or” includes “and” and vice-versa. Non-limiting terms are not to be construed as limiting unless expressly stated or the context clearly indi-cates otherwise (for example “including”, “having” and “comprising” typically indicate “including without iimita-tion”). Singular forms including in the claims such as “a”, “an” and “the” include the plural reference unless expressly stated otherwise.

Any articles, patents, patent applications, and other publications that have been cited in this disclosure are incorporated herein by reference. Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

This invention relates to orders placed online from local merchants (Grocery, liquor and other retail). The items are selected and checked out at a merchant establishment by a “Picker,” who may be a store employee or a third party. After checkout, the item may be delivered to the customer by a delivery driver or picked up at the merchant by the customer.

The present invention enables real-time or near real-time access to and communication with point of sale systems. Items available for purchase in-store are made available for purchase through “Online Platform(s)”. These items made available for purchase online may correspond with items available in-store which are stored in the point of sale system for in-store purchase through the use of a database or other storage unit and may contain Universal Product Codes (“UPC codes”), stock keeping unit (“SKU”) or other item identifiers as well as other product details such as size, price, weight, quantity, manufacturer etc. In-store items available for purchase online may be made accessible to a consumer or other entity (such as an “Online Platform”), enabling the consumer to select a particular entity with which to deal. The consumer or Online Platform could also display a listing of items available for purchase across a plurality of the entities, so as to avoid the need to explicitly select a particular entity with which to interact.

The present invention includes an order manager which may comprise an order interface enabling one or more consumers to access the order manager and thereby place an order online, the details of which will then be mapped to the point of sale agent and/or database or other storage unit. For example, the order interface may enable the one or more consumers to purchase items that are typically available at a specific merchant and then map that order data to the POS agent and/or POS system utilized by that merchant. For example, purchase data may include a business identifier, an item or service sold by the business, a price, a description, a size and/or weight, a manufacturer of the product, a quantity etc. This item data may be accessible to a consumer by the order interface. The consumer may purchase the item(s) from the business via the order interface. The order interface may then communicate with a POS system corresponding to the business by means of its corresponding point of sale agent.

The present invention also provides a system, method and computer program for linking an order that was placed online using the order manager with (a) a person who will gather the order in-store that was placed online for pick-up or delivery; and (b) an order that has been entered into the POS in the store.

The point of sale system(s) may be owned and/or administered by one or more entities and/or related entities. For example, the entities may be unrelated retailers, related retailers (for example, franchises), or outlets of a commonly owned retailer. The retailers may be in any field of retailing, such as sellers of goods and services, grocery stores, liquor stores, convenience stores etc. The entity could also be a reseller or aggregator rather than a retailer, or a vendor of goods outside of a retail environment.

The point of sale systems may be provided by a third party or be custom/proprietary point of sale systems. Typically each point of sale system is provided on a computer, such as a personal computer, on site at a particular business location. However, it should be understood that the present invention is not to be limited to any particular configuration of a point of sale system, For example, a particular point of sale system for a franchisee may be located on a server computer at a franchise head office or in the cloud using services such as Microsoft Azure, Amazon Web Services (AWS) or other similar services.

The present invention assigns a unique identifier linked to the order placed online and then maps that unique identifier along with the order information to each of (a) the person who will be gathering the items in-store; and (b) to the POS agent and/or POS system found at the associated store, both of which can reside either in-store or in the cloud.

The unique identifier and order details for the order are then stored in a storage system such as a database or other storage system. The storage system for storing the details of the unique identifier and online order information can reside in the cloud and/or at the store level. It can also reside in the POS Agent and/or on the POS system, The unique identifier and online order information remains in the storage unit until such time that the person gathering the items that were ordered online enter the items into the POS system and input their unique identifier into the POS and until the checkout process is complete.

The present invention provides a way to enter the unique identifier that is tied to the online order into the point of sale system before, during or after the person gathering the in-store items has finished entering those items into the in-store POS system. The unique identifier may be entered into the system using a QR code, bar code or other method that is scanned at the POS using a variety of different types of scanners, or may be entered into the POS manually or through a variety of other ways to enter the unique identifier into the POS system. Once the unique identifier is entered into the POS, the in-store order data that is entered into the POS is then compared to the online order data that is linked to the unique identifier using the Equivalency Machine.

The system and method for comparing online orders with items that have been entered into an in-store POS system may also comprise an order manager linked to the one or more point of sale agents either directly or through another intermediary software service such as an API or other service. The one or more point of sale agents may be operable to communicate online order data to the one or more point of sale systems, the Equivalency Machine and/or the order manager. The Equivalency Machine may also be built into the point of sale agent.

It should be understood that the present invention is not limited to any type of entity and that it could also be used for a plurality of entities that operate in different spaces, such as a retailer and a non-retailer, etc.

The present invention provides an Equivalency Machine linked to the POS agent and/or POS system either directly or through an intermediary software service such as an API or similar service. The Equivalency Machine may store data corresponding to the items that were purchased online in a database or other storage unit. The Equivalency Machine also stores and/or accesses a set of rules that can be applied when comparing the order that was purchased online with the order data that has been entered into the point of sale system.

The rules that are applied when comparing items that were entered into the in-store POS to the order that was placed online are configured to determine whether or not the items that were entered into the in-store POS meet the acceptable criteria of the order that was placed online. Acceptable criteria are based on a set of rules that can either be applied to all orders, or can be dynamic based on a specific order, items within an order or other criteria such as time of day, location etc. These rules can be static or dynamic and can be defined and/or configured in a variety of different ways based on a long list of criteria.

A point of sale database may be provided in the cloud, in the POS agent, in the Equivalency Machine and/or on the POS system for storing online order data. The point of sale database may be linked to the order manager either directly or indirectly through an intermediary piece of software such as an API for example. The point of sale database may be useful for replication of point of sale data, so as to reduce communication requirements between the order manager and the potentially remotely located point of sale systems. In such a case, the point of sale database could be updated or refreshed from time to time, for example based on a polling model or subscription model.

In a polling model, for example, the Equivalency Machine may be operable to compare the point of sale data at the one or more point of sale systems with the order details of the order placed online. If the Equivalency Machine detects a modification to the order that was placed online when comparing it with the items that have been entered into the POS, the Equivalency Machine may selectively choose to accept or deny the modification. In a subscription model, for example, the order manager may notify the point of sale agent of a modification to the online order. Alternatively, the point of sale agent may notify the order manager of modification(s) to the order as entered into the in-store POS. The order manager and/or point of sale agent may be operable to update the order with modified order details in response to a notification of modification.

If the Equivalency Machine accepts all modifications to the order, it notifies the cashier and/or the person collecting the items in the order that the order is acceptable. This notification can happen on the POS or a variety of other ways such as through a mobile application on a mobile phone. Similarly, if the items) entered into the in-store POS system do not meet the acceptable criteria, the Equivalency Machine will notify the cashier and/or the Picker of the discrepancy via either the POS system, a mobile phone or other method and will not allow them to complete the transaction. In the event that the transaction cannot be completed, the cashier and/or Picker can either cancel the transaction entirely, modify the items that are entered into the POS by removing an item, replacing an item, adding an item or any number of other actions required to meet the acceptable criteria of the online order and can then start the process over to enter the unique identifier into the POS. This process is repeated until such time that the order is either cancelled or completed successfully. Alternatively, the cashier and/or the Picker may have the ability to override the decision made by the Equivalency Machine and accept all items that have been entered into the POS. This action may be taken by the Cashier or the Picker on the POS, through a mobile device or a variety of other methods/devices.

Once the process is either cancelled or completed, the necessary data on the end-state of the transaction is stored in a database or other type of storage unit and is then shared with the online platform and/or the retailer either in real-time and/or at a set time such as a batch at the end of the day that includes all transactions for that day in one report. This information can then be used for accounting and reconciliation purposes between the two entities and to ensure transparency between the two parties as to what items and price each online and in-store order was charged. For example, as part of accounting and reconciliation, the Provider will transfer to the merchant the appropriate amount of funds it received as payment when the online order was made with the Provider. If the final amount of the order is less than the amount the Provider received, the Provider may send a refund or credit to the customer. If the amount of the order is greater, the Provider may charge the customer the difference in accordance with the Provider's agreement with the customer.

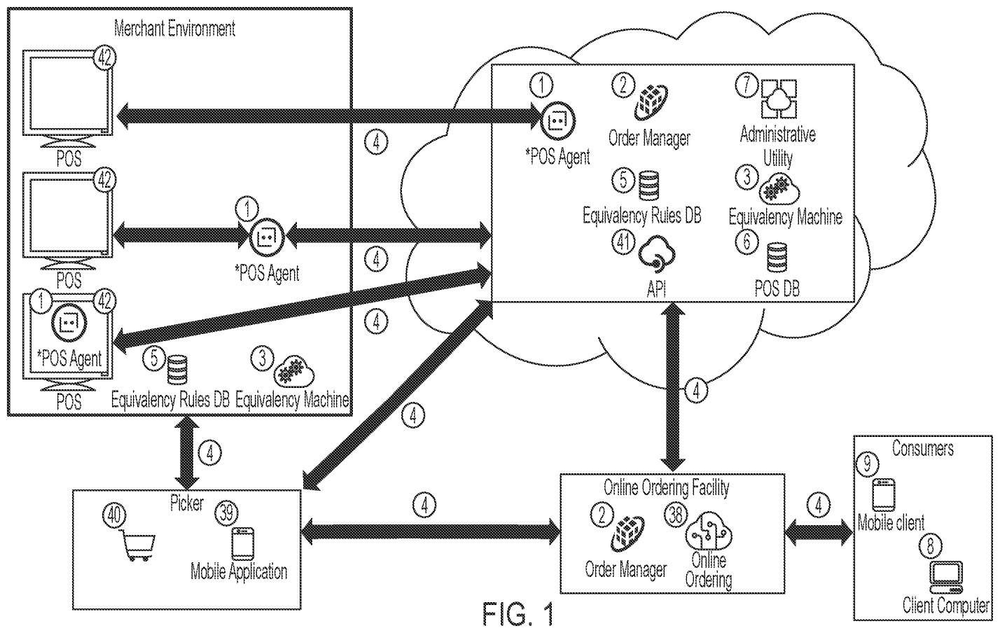

FIG. 1 illustrates a system in accordance with the present invention. The system may comprise one or more point of sale agents (1), an order manager (2) an Equivalency Machine (3) linked by a network (4), such as the Internet. The one or more point of sale agents (1), the order manager (2) and the Equivalency Machine (3) may be hosted by one or more centrally located or distributed computers linked to each other by means of a network such as the Internet, including in a cloud computing environment. Optionally, one or more of the point of sale agents (1) may be provided on site at the merchant environment for the corresponding point of sale system. The one or more point of sale agents, the order manager (2) and the Equivalency Machine (3) may be provided by one or more computer programs which when executed by a computer processor are operable to provide the features described herein.

The system may also include a point of sale database (6), and Equivalency rules database (5), which are described below. The system may also include an administration utility (7), which is described below.

The point of sale database (6) can be located in the cloud or other locations including but not limited to the merchant environment and can be configured to store order information for orders placed online and/or items that have been entered into the in-store POS system.

Although Equivalency Machine (3) is shown in the cloud in FIG. 1, it could alternatively be located in the Online Ordering Facility. The Online Ordering Facility could predetermine what items are acceptable alternatives for the items ordered online and pass that information for comparison between the items in the online order and the selected items. In this scenario, Equivalency Machine (3) spans between the Online Platform and the in-store system. Thus, the equivalency rules database (5) can also be hosted in the cloud or other locations including but not limited to the merchant environment or with the Online Ordering Facility and can be configured to house a set of acceptable rules for the Equivalency Machine to follow when comparing orders that were placed online with orders that have been entered into the in-store POS system. There is no limit to the number of rules or the type of rules that are stored in the equivalency rules database. Alternatively, these rules can also exist in forms other than in a database such as other types of memory storage unit or can be applied in real time when in communication with other facets of the system.

The administration utility can be hosted in the cloud and/or at the merchant environment and can be accessible via a web or mobile browser on a computer or mobile device. The administration utility can be used to set and configure the rules to be utilized by the Equivalency Machine when comparing orders online with orders entered into the store. The administration utility may also include a number of other applications including but not limited to accounting and reporting functions, or may be integrated to other third-party software that performs these functions (for Example, Quickbooks) among other things.

The system may be accessible by a consumer by means of a client device, such as a client computer (8) or mobile device (9). The client device may include or be linked to a web browser or mobile application for accessing the order manager (2) and/or items available for purchase and disseminated via third party website or mobile application (38).

The system illustrated above shows one example where a consumer could access the order interface (2) (38) and browse a listing of items accessible from the one or more entities and could place an order for one or more items. The purchase could be completed in real-time based on the product catalogue typically offered by the corresponding merchant. The order can therefore be placed directly through the order manager with the belief that the product(s) ordered by the consumer are typically available at the specified retailer.

A separate order interface may be provided for different media that are used to access the order manager. For example, a mobile web page may be provided for accessing the order manager from a mobile device, and/or an application may be provided for accessing the order manager from a computer and/or mobile device and/or proprietary system. The order interface may also be accessible by an API (41) that can be used on social networking websites, search engine websites, retailer websites, retail websites, etc.

Once a consumer accesses the order interface, the order manager may generate an order session for tracking and recording the status of a particular order. The order manager may also maintain a record of past and pending orders. For example, a consumer may access the order manager by means of the order interface to initiate an order. The consumer may partially configure an order but not complete the order, or may configure an order in a sequence of steps. The order manager may save the order status for future retrieval. Correspondingly, the order manager may maintain consumer accounts for enabling retrieval of past and pending orders, or to provide a consumer with a list of favorite entities, orders, etc. based on past behaviour.

The order manager may communicate orders made by a consumer from the order interface to the point of sale systems hosted in the merchant environment, in the cloud or other similar locations, When an order is submitted to the order interface (38) (2), it may be communicated to the respective point of sale system by means of a point of sale agent (1). Once the items are gathered at the store and entered into the point of sale system (42) and the unique identifier that is associated with the order that was placed online is entered into the system as described in more detail below, the Equivalency Machine may approve or deny the order and notify the point of sale agent of this status. The order status may then be communicated by the point of sale agent to the order manager and/or the POS system, and displayed to the appropriate parties via the POS system (42), mobile application (9) (39) or a variety of other ways (8) (38) (40).

Certain aspects of the system may also be accessible by a Picker by means of a mobile device (39), including but not limited to the order manager (2), Equivalency Machine (3) or indirectly to an API (41), POS DB (6) etc. The Picker may have the ability to communicate with the consumer via a mobile browser or mobile app (39) on their mobile device if/when one of the items they ordered online are not available in the store and the consumer may have the ability to respond to the Picker via a mobile application or mobile browser (9) and provide feedback to the Picker on what item(s) are acceptable replacements for them.

In situations where the Picker and consumer are able to communicate directly, the acceptable alternatives that have been communicated by the consumer to the Picker may be entered directly into the Equivalency Machine as acceptable replacement items which can then be substituted for the items that were originally ordered online at the time of checkout. Alternatively, the Provider/Online Platform can send a list of acceptable alternative items to the Equivalency Machine, rather than requiring the Equivalency Machine to determine what items are acceptable. The Equivalency Machine could also be configured to accept any alternative provided by a Picker for a specific item. These different scenarios represent some but not all of the potential ways that a Picker can communicate with the consumer and/or the online platform and/or the Equivalency Machine to determine acceptable substitutes for items ordered online.

Once an order is placed online, the Order Manager (2) and/or the Online Ordering Platform (38) will generate a unique identifier and assign it to all of the details of each order that is placed online. That unique identifier may then be provided to the Picker via a mobile application, mobile browser or other method via a variety of different formats including but not limited to QR codes, bar codes, a unique Code. This unique identifier will then be used by the Picker at the time of the in-store checkout to link the details of the order that was placed online with the details of the order that they have gathered and entered into the in-store POS system.

Although the unique identifier may be assigned to a corresponding Online Order at the time of the online purchase, the unique identifier and/or the corresponding order data that is linked to said identifier can be updated and changed at any time during this process right up to the point of the final checkout and transaction.

The communication link between the point of sale agent and its corresponding point of sale system may be secure, for example by implementing an encryption technique and/or authentication, such as a mutual authentication technique. For example, both the point of sale agent and the point of sale system may be provided with a certificate to identify themselves with each other to establish explicit trust for any given communication.

The point of sale agent may also be provided with constrained rights to minimize its capabilities in affecting point of sale data on the point of sale system. For example, the point of sale agent may be given read-only rights to “pricing” or “item” point of sale data for a retail point of sale system, but read-write access to “ordering” point of sale data to enable remote ordering of items by a consumer. Any or all of these or other similar security measures may also be implemented in the link between the point of sale agent and the order manager.

Each point of sale agent may be operable to communicate point of sale data between its corresponding point of sale system and the order manager and/or by mapping the point of sale data to a Equivalency Machine. The Equivalency Machine requires the point of sale data for point of sale systems to conform to a set of rules that can be configured to provide an integrated or unified system. The point of sale agents are operable to map point of sale data for any particular point of sale system to the Equivalency Machine, so as to compare the order entered into the in-store POS system with the order that was placed online. The POS agent enables both interoperability between point of sale systems, and scalability of the system as a whole. Each point of sale agent may also enable remote provisioning and local point of sale system diagnostics.

The point of sale data mapped to the Equivalency Machine may include static and dynamic data. For example, in the context of a retail implementation, the point of sale data for each point of sale system may include a retail identifier (which may be static), delivery areas (which may be static), products (which may be static), pricing (which may be dynamic) and promotions (which may be dynamic). By mapping the point of sale data for each point of sale system to the Equivalency Machine, all point of sale data can be provided and compared based on real-time data provided by the POS system and/or the order manager. The mapping of point of sale data by the point of sale agent may be configured by a system administrator or learned based on heuristics as the system expands.

The order manager is operable to access each of the point of sale systems by means of the corresponding point of sale agent by communicating order data therewith. The order manager may be provided with real-time or near real-time access to the order data for each point of sale system and each online platform. The order manager may optionally access replicated point of sale data from a point of sale database. A point of sale database may be linked to the order manager for storing point of sale data for one or more of the point of sale systems. The point of sale database may be updated or refreshed from time to time, for example based on a polling model or subscription model. Providing a point of sale database may be advantageous to reduce the need for communication of point of sale data between the point of sale systems, point of sale agents, and order manager, particularly where the point of sale data is static. For example, if a consumer is interested in static point of sale data such as a retail products/items, this information does not typically need to be refreshed instantly. At the time of a purchase of one or more items in an order, however, it may be preferable to communicate with the point of sale and/or the online platform to establish a current price for the one or more items.

In a polling model, for example, the order manager may be operable to compare the point of sale data at the one or more point of sale systems with the point of sale data stored in the point of sale database. This comparison can be made based on a preconfigured time interval (for example, every five seconds, five minutes, one day, etc.) or each time some particular point of sale data is communicated to the corresponding point of sale agent (for example, for an “order”). If the order manager detects a modification, the order manager may selectively update the point of sale database.

In a subscription model, for example, the one or more point of sale agents may notify the order manager of a modification to the point of sale data. This can be provided, for example, where the particular point of sale system includes an application programming interface (API) that notifies the point of sale agent of a modification. The point of sale agent can then initiate a corresponding notification to the order manager, which may be operable to update the point of sale database with modified point of sale data.

The order manager may also monitor connectivity status to each point of sale by means of each point of sale agent. For example, connectivity status may be monitored by each point of sale agent using an API provided by each point of sale system. The connectively status can be communicated from the point of sale agent to the order manager. The order manager may maintain a connectivity status list for recording the last known connectivity status of each point of sale system. If connectivity is lost to any particular point of sale system, the corresponding point of sale agent may notify the order manager of this status. If a consumer completes a transaction with a retailer who's POS system is currently offline, the order manager can inform the online platform who can modify its order process to deal with the current limitation.

Furthermore, the order manager can request a connectivity status update from any particular point of sale agent based on a preconfigured time interval, such as every five seconds, and the point of sale agent may correspondingly obtain the connectivity status for the point of sale system and communicate the connectivity status to the order manager. If connectivity is lost to any particular point of sale agent, the order manager can provide similar functionality as in the case of a point of sale system losing connectivity, as described above.

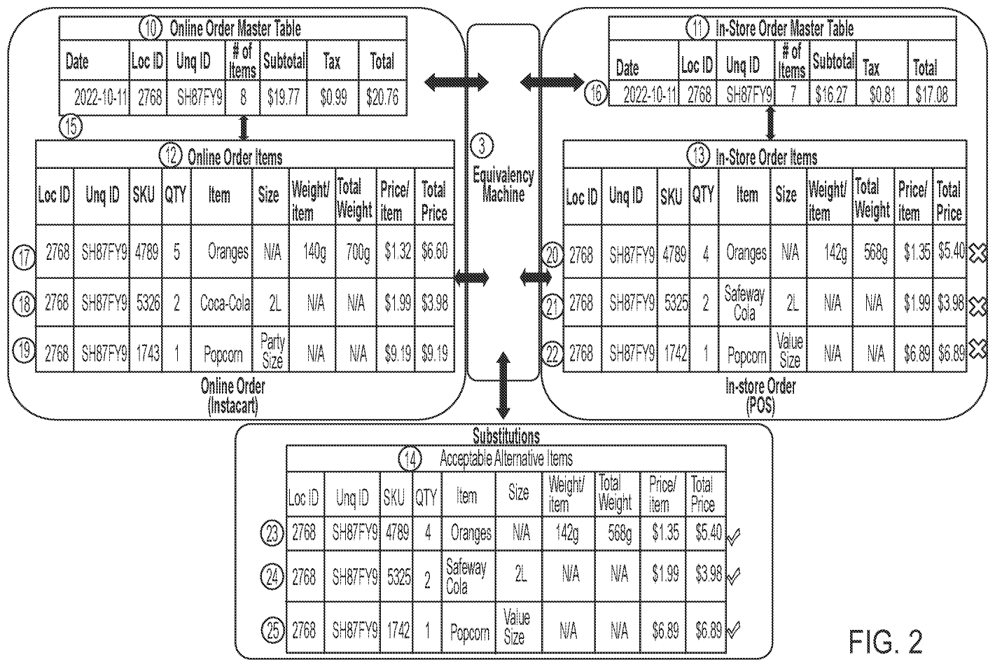

FIG. 2 Illustrates a high-level view of the Equivalency Machine including one potential embodiment of the tables in the POS Database (6) that store data for the Online Order and the order entered into the in-store POS (42) as well as the Equivalency Machine (3). The Equivalency Machine takes the order details from the Online Order Tables (10) (12) and uses an algorithm that compares the details of that order (15) (17) (18) (19) with the details of the order stored in the in-store POS system database tables (16) (20) (21) (22). As illustrated in FIG. 2, discrepancies exist between the information in the Online Order Master Table (10) and the in-store order master table (11). Specifically, the Date, Loc ID, and Unq ID all match perfectly between the two tables, however the # of items, subtotal, tax and total have discrepancies between the two tables, which indicates that there are differences between the order that was placed online and the order that has been entered into the in-store POS system.

When you drill down further to compare each individual item located in the Online Order Items Table (12) and the In-store Order Items Table (13), the Equivalency Machine will find discrepancies between the items that were ordered online and the items that have been entered into the in-store POS system. These discrepancies are described in greater detail below.

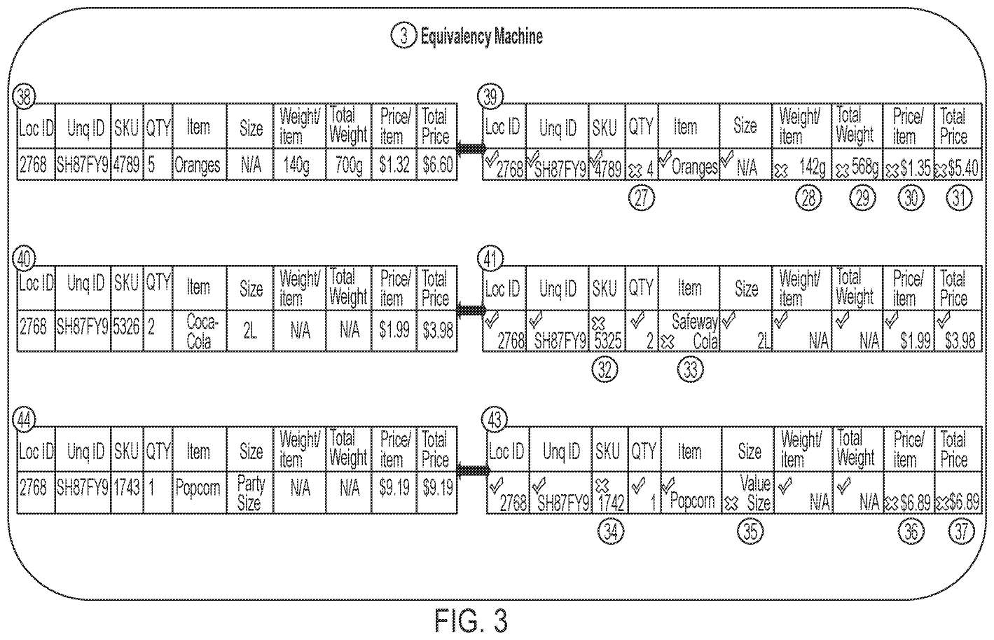

For example, when comparing the first item in the Online Order items table (17) with the items in the in-store order items table (20) the Equivalency Machine notes that there are aspects of each entry that is an exact match in some but not all of the characteristics of these two items. Specifically, the Loc ID, Ling ID, SKU, Item and Size perfectly match between the item entered into each database table, however there are discrepancies between the QTY, Weight/Item, Total Weight, Price/Item, and total price. This is illustrated and described in greater detail in FIG. 3. Below.

Once the Equivalency Machine has determined that there are discrepancies between the items that were ordered online and the items that have been entered into the in-store POS system, it uses an algorithm to apply a set of rules to determine whether or not the items that have been gathered in-store are acceptable alternatives to the items that were originally purchased online as illustrated in FIG. 3. Alternatively, rather than applying the standard set of rules, the Equivalency Machine may be supplied with a list of acceptable alternative items by the Provider or by the Picker (either ahead of time, in real-time or near real-time) which it can then use to determine whether or not the alternative items entered into the POS system match are acceptable alternatives for the items ordered online.

The Equivalency Machine may monitor orders that are currently in progress, initiate notifications to be sent to owners/administrators on any potential issues, record metrics, and deactivate expired rules. The Equivalency Machine may provide historical data for rules to enable optimum configuration of future rules.

FIG. 3 Illustrates a more detailed comparison of the items that were purchased online with the items that have been entered into the in-store POS system. In this illustration, the algorithm in the Equivalency Machine starts with the first item in the order (38) and cycles through each item in the order that have been entered into the in-store POS to find the closest match to the first item in the online order.

In this case, the closest match to the item that was ordered online (38) is the item listed in the In-Store POS system (39) which has identical Loc ID, Ling ID, SKU, Item and Size, however there are discrepancies found in the QTY, Weight/Item, Total Weight, Price/Item and Total Price. Once the Equivalency Machine determines the closest match to the item ordered online and identifies any discrepancies between the item ordered online and the item that has been entered into the in-store POS system, the Equivalency Machine then uses the algorithm to look through a set of rules that apply universally and/or to this specific item to see if the item that has been entered into the in-store POS system is an acceptable alternative to the item that was ordered online. Alternatively, if the Equivalency Machine is unable to find a close match to one of the items ordered online, the Picker or Cashier may be given the ability to choose an item that was entered into the POS to be an acceptable alternative for a specific item that was ordered online.

For example, the rules applied by the algorithm to the first item listed in the Online Order Items Table (38) allow for the items that were entered into the in-store POS system to be up to a maximum of 10% higher in Weight/Item, Total Weight, Price/Item and Total Price but no more than a maximum of 10% higher. Additionally, the rules also allow for any of those same characteristics to be lower by any amount than what was purchased online, however the rules do not allow for a higher number/amount when it comes to QTY or Total Price. In this example, the algorithm in the Equivalency Machine determines that because the replacement item (39) found in the in-store POS system meets the acceptable rules applied to the item that was ordered online, the replacement item meets the acceptable criteria and is accepted by the Equivalency Machine as a result.

In the second example, the item in Online Order (40) is found to most closely match the item entered into the in-store POS (41). When comparing the two items, there is an exact match when it comes to Loc ID, Ung ID, QTY, Size, Weight/Item, Total Weight, Price/Item and Total Price, however there is a discrepancy between the SKU and Item.

The rules applied by the algorithm to these items allow for the item online to have a specific list of acceptable alternative items provided to the Equivalency Machine. As one example, the item named “Coca-Cola” with SKU #5326 has a list of acceptable alternative items that can be substituted for the item ordered online if the item ordered online is not available in-store. In this example, Alternative items listed for “Coca-Cola” with SKU #5326 might include “Pepsi” with SKU #5327″ or “Safeway Cola” with SKU #5325. The rules engine may also stipulate that the size of “2L” has to be the same between the item ordered online and the item entered into the in-store POS system, Given that the item entered into the in-store POS system is listed as and acceptable alternative to the item ordered online, the item entered into the in-store POS system is approved by the Equivalency Machine.

In the third example illustrated in FIG. 3, the item listed in the Online Order Table (42) is found to most closely match the item found in the in-store POS system (43). In this case, the Loc ID, Unq ID, quantity, item, Weight/Item and total weight are all a perfect match for the item that was originally ordered online, however there are discrepancies between the SKU, Size, Price/Item and Total Price.

For this item, the rules applied by the algorithm provided by the Equivalency Machine dictate that the alternative items can be of the same size or smaller, but may not be bigger. The rules also dictate that the price can be less than the price listed online but that it is not acceptable for the price to be higher. When applying these rules to the item listed in the in-store POS system as compared to the item that was ordered online, the algorithm determines that the item listed in the in-store POS system is an acceptable alternative to the item ordered online and is approved by the Equivalency Machine.

Given that all three items that were included in the Online Order meet the acceptable criteria for substitutes to the items that were ordered online, the order as a whole is then also approved by the Equivalency Machine and deemed acceptable.

Once the order as a whole is deemed acceptable by the Equivalency Machine, it communicates this to the POS agent which then marks the order as “paid” in the in-store POS system and the order is complete.

It is important to note that the rules described above are just a few examples of rules that could be applied by the Equivalency Machine and that there is no limit to the number of rules or types of rules that are applied by the Equivalency Machine.

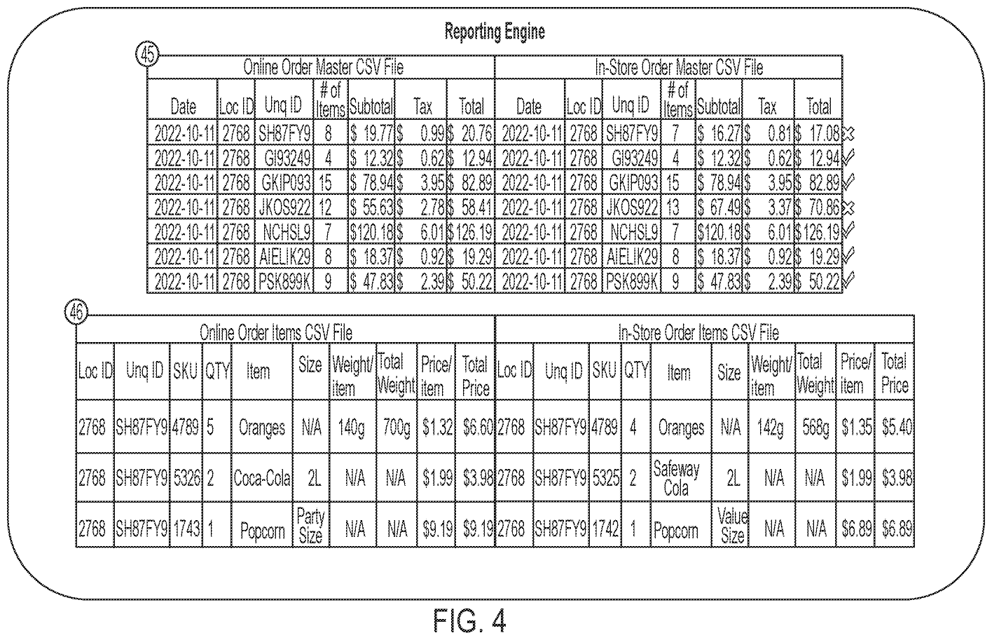

FIG. 4. Illustrates one potential embodiment of the Reporting Machine which can be configured in a variety of ways. The example illustrated above shows a spreadsheet with one tab (45) showing a list of all the Online Orders for a specific location (Location 2768) on a specific day (2022-10-11) side by side with all of the corresponding orders that were entered into the in-store POS system. A second tab (45) also shows a list of items that correspond to any orders from the first tab (45) that had discrepancies in it. The second tab shows a side by side comparison of every item that was ordered online with the corresponding items that were entered into the in-store POS system.

These orders and items in each order may communicated to the appropriate parties, which may include but not be limited to the Merchant where the items were entered into the in-store POS system and the Online Platform where the online order was placed. These reports can be communicated in real-time, or at a set interval such as daily, weekly or monthly (or any other time increment as desired). Communication of this data can be performed in a variety of ways, including but not limited to via an API, via email to the appropriate parties at scheduled times, via download on-demand in an online portal or a number of other similar options. The format of the reports may also vary, with options ranging from CSV or Microsoft Excel files, Adobe PDF documents or any number of other formats as desired.

By automating this reporting to the Merchant and the Online Platform, it will eliminate the need for these different parties to manually share files with each other, perform manual reconciliation on a daily, weekly or monthly basis, and will enable greater transparency and reduced costs between these two entities. Thus, the Provider can transfer to the merchant the appropriate amount of funds it received as payment when the online order was made with the Provider, which may be modified if the final amount of the order is less than the amount the Provider received from the customer or more than the amount the Provider received.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The following claims are thus to be understood to include what is specifically illustrated and described above, what is conceptually equivalent, what can be obviously substituted. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

1. A system for facilitating in-store checkout for items ordered online, comprising: a first computer processor coupled with at least one point of sale agent, each agent coupled to at least one point of sale system, wherein each point of sale system can generate an order from items entered into the point of sale system;
a second computer processor coupled to the first computer processor, the second computer processor configured to operate an order manager coupled to at least one point of sale agent;
a third computer processor, coupled to the second computer processor, configured to provide a unique identifier code;
and a memory storage unit, coupled to the point of sale agent, storing a point of sale database, wherein the point of sale database is configured to store at least one of order information for orders placed online and information for items entered into a point of sale system. cm 2. The system of claim 1, wherein the first computer processor, the second computer processor and the third computer processor are separate processor devices.

3. The system of claim 1, wherein the order manager comprises an order interface enabling a consumer to access the order manager to place an order online.

4. The system of claim 1, wherein data is provided to the order manager from a point of sale agent.

5. The system of claim 1, wherein data is provided to a point of sale agent from the order manager. cm 6. The system of claim 1, wherein the unique identifier code is provided to a Picker. cm 7. The system of claim 1, wherein the unique identifier code is used to link the details of the order placed online with the details of the items entered into the point of sale system and is provided to an Equivalency Machine to compare the details of the order placed online with the details of the items entered into the point of sale system. cm 8. The system of claim 7, wherein the details of the order placed online and the details of the items entered into the point of sale system are provided to the Equivalency Machine, which applies a set of rules to compare the details of title items entered into the point of sale system with the details of the items in the order placed online to verify that each entered item is either identical to, or is an acceptable substitute for, an item in the order placed online.

9. The system of claim 7, wherein the Equivalency Machine approves or denies the order generated from items entered into a point of sale system after the comparison and provides a notification of the approval or the denial.

10. The system of claim 9, wherein, the Equivalency Machine notifies the Picker when the Equivalency Machine approves or denies the order.

11. The system of claim 9, wherein, the Equivalency Machine notifies the cashier at a point of sale system when the Equivalency Machine approves or denies the order.

12. A network for integrating POS systems with an Equivalency Machine to determine the accuracy of items selected by a Picker in-store compared with items ordered online, comprising an Equivalency Machine having a set of rules to compare details of items ordered online with details of items entered into an in-store POS system to verify that each of the items entered into the in-store POS system is either identical to, or an acceptable substitute for, an item ordered online. cm 13. The network of claim 12, wherein the details of the items entered into an in-store POS system that are used by the Equivalency Machine include at least one of static data and dynamic data.

14. The network of claim 12, wherein the Equivalency Machine is operable to compare details of items entered into an in-store POS to details of items ordered online stored in a point of sale database.

15. The network of claim 12, wherein one or more point of sale agents provide notification of modifications of details or of substitutions of items entered into an in-store POS system.

16. The network of claim 12, wherein the Equivalency Machine and the point of sale agent are adapted to monitor orders in progress, initiate notifications, record metrics and deactivate expired rules.

17. The network of claim 12, wherein a report engine is provided to generate reports containing information relating to the items ordered online and the items entered into the POS that have been compared by the Equivalency Machine.

18. A system for improving fulfillment by a Picker of an online order made to a retail establishment, comprising:
an order interface to transmit information concerning products available for purchase at the retail establishment to a consumer and to receive the online product order from the consumer;
a memory storage unit coupled with the order interface, the memory storage unit storing a database containing information about each product available for purchase at the retail establishment;
an order manager coupled with the order interface for receiving information sent by the consumer;
an Equivalency Machine containing rules for determining products available for purchase that are acceptable substitutes for the products ordered by the consumer;
a scanning device at the retail establishment for scanning products selected by the Picker in fulfillment of the order; and
at least one computer processor coupled with the order manager, the Equivalency Machine and the scanning device, the processor adapted to verify that each product selected by the Picker corresponds to one of the ordered products or to one of the products identified by the Equivalency Machine as an acceptable substitute for one of the ordered products.

19. A system of claim 18, wherein a weight scale at the retail establishment provides information about products selected by the Picker to verify that the products correspond to one of the ordered products or to one of the products identified by the Equivalency Machine as an acceptable substitute for one of the ordered products.

20. The system of claim 1, wherein a report engine is provided to generate reports that compare and reconcile differences between order information for orders placed online and information for items entered into a point of sale system
